(19) United States
(12) Patent Application Publication
(10) Pub. No.: US 2006/0186125 A1
(43) Pub. Date: Aug. 24, 2006

(54) Thermally insulating containers

(76) Inventor: Stephen Tew, Oxon (GB)

Correspondence Address: WENDEROTH, LIND & PONACK, L.L.P., 2033 K STREET N. W., SUITE 800, WASHINGTON, DC, 20006-1021, US

(21) Appl. No.: 11/353,209

(22) Filed: Feb. 14, 2006

Related U.S. Application Data
(63) Continuation-in-part of application No. PCT/GB04/03361, filed on Aug. 3, 2004.

(30) Foreign Application Priority Data
Aug. 15, 2003 (GB) 0319131.9
Nov. 24, 2003 (GB) 0327312.5
Jan. 24, 2004 (GB) 0401564.0
Mar. 17, 2004 (GB) 0405990.3
Jun. 4, 2004 (GB) 0412502.7

(51) Int. Cl. A47J 41/00

(52) U.S. Cl. 220/592.27

(57) ABSTRACT

A beverage container comprising a body section comprising an outer metallic wall and an inner wall, the inner wall defining an inner space for containing a liquid or material, a space adjacent to the inner wall being substantially evacuated to provide thermal insulation to the inner space, and an open-only lid sealingly attached to the body section to close an opening therein.

### FIELD OF THE INVENTION

The present relation relates to containers and in particular, though not necessarily, to containers for fizzy or carbonated beverages. The present invention also relates to a thermally insulating material and to containers made therefrom.

### BACKGROUND TO THE INVENTION

Consumers are used to purchasing ready-made drinks in either metallic, glass, or plastic containers. Metallic containers are typically of the “can” type having an open only mechanism such as a ring-pull, whilst glass and plastic containers are typically in the form of a bottle with a screw on lid. Of the various materials, metal might be considered the most preferred, firstly because it gives the drinker the best perceived taste, secondly because the materials used are generally recyclable, and thirdly because metallic containers are in practice unbreakable. Glass might be considered the second choice material because it is both recyclable and gives a good taste sensation, with the disadvantage that glass containers are breakable. Plastic might be considered the third choice material because of the perceived poor taste quality which it provides.

A problem with a standard beverage container is that, after removal from a cold storage environment, the temperature of the liquid within the container starts to rise due to heat transfer with the external environment. In the case of most soft drinks, this is undesirable. The problem is particularly acute in the case of metallic containers as the metal walls conduct heat rapidly into the interior space.

Metallic beverage cans having improved thermal insulating properties are known in the prior art. For example, JP3254322 describes a dual tube construction can body, the space between the two tubes being either evacuated or filled with a heat insulating material. U.S. Pat. No. 6,474,498 describes a container having an outer can and an inner liner of “bubble wrap” material. However, the known improved cans suffer from a number of disadvantages including: high cost, insufficient thermal insulation, poor recycleability, difficulty of manufacture, and an inability to cope with a pressurised content.

### SUMMARY OF THE INVENTION

It is an object of the present invention to overcome the disadvantages of existing beverage containers as outlined in the previous paragraphs. It is an object of the present invention to provide a thermally insulating material which is both flexible and lightweight and is suitable for use in beverage containers.

According to a first aspect of the present invention there is provided a beverage container comprising:
a body section comprising an outer metallic wall and an inner wall, the inner wall defining an inner space for containing a liquid or material, a space adjacent to the inner wall being substantially evacuated to provide thermal insulation to the inner space; and
an open-only lid sealingly attached to the body section to close an opening therein.

According to a second aspect of the present invention there is provided a temperature indicator for indicating the internal temperature of an insulated container, the temperature indicator arranged to be disposed on the external surface of the container to provide a visual indication of the temperature of its contents, the indicator reacting to the ambient temperature with a delay corresponding substantially to the thermal delay introduced by the walls of the container.

The unique point about this indicator is that it does not come into direct contact with the contents of the container and only needs to measure the ambient temperature outside the container, yet still indicates the temperature of the contents. This is particularly useful in the case of insulated containers. When using a thermally insulated container people may have difficulty, for example, knowing or recalling how long the container has been in a refrigerator and if the contents are sufficiently cool to consume. The invention solves this problem. Additionally, the inventive indicator helps to show when a hot beverage is safe to drink without the fear of scalding.

Preferably, the thermal indicator is arranged to indicate only two states, e.g. warm and cool, with a predefined boundary temperature separating the two states, e.g. a temperature in the range 10 to 15 degrees Celsius.

Preferably, the delay inherent in the thermal indicator is in the range 4 to 8 hours.

According to a third aspect of the invention there is provided a thermally insulating material comprising:
first and second opposed flexible sheets, the sheets being impermeable;
spacer means which is in contact with both the first and second sheets,
wherein the space between the first and second sheets is substantially evacuated

Preferably, the first and second sheets are of a plastics material. Each sheet may be coated on one or both sides with a reflective metallic material.

Preferably, the spacer means is of a material which has a high porosity. More preferably, the material is an aerogel or a super-insulator. The spacer means may comprise a plurality substantially spherical spacer elements, although other shapes may also be used.

Preferably, each element is secured to one or both of the sheets or to another element using an adhesive.

The spacer means may comprise a sheet or blanket of aerogel material.

According to a fourth aspect of the present invention there is provided a beverage container comprising, a substantially rigid outer container and an inner container disposed within the outer container, the inner container comprising:
first and second opposed flexible sheets, the sheets being impermeable;
spacer means which is in contact with both the first and second sheets,
wherein the space between the first and second sheets is substantially evacuated,
the combined sheets being shaped to provide an inner, insulated space for containing a beverage.

The spacer means may comprise a sheet or blanket of aerogel material. Alternatively, the spacer means may comprise a multiplicity of spacer elements, each formed of aerogel material. The elements may be arranged in a single layer or in multiple layers, and may be adhered together.

According to a fifth aspect of the present invention there is provided a beverage container comprising a body section having an outer wall and an inner wall, the inner wall defining an inner space for containing a liquid or material, a highly porous material substantially filling the space between the inner and outer walls, wherein the space containing the highly porous material is substantially evacuated.

According to a sixth aspect of the present invention there is provided a method of providing a visual indication of the historical temperature to which a product or material has been exposed, the method comprising placing a thermal indicator in thermally conductive contact with the product or material, the thermal indicator providing a visual indication of temperature and comprising a thermally sensitive material which exhibits a time-lag response.

Preferably, the time-lag response causes the visual indication of temperature to lag the temperature of the product or material by at least one hour.

Other aspects of the invention are set out in the accompanying claims.

### BRIEF DESCRIPTION OF THE DRAWINGS

FIG. 1 illustrates a conventional beverage can;

FIG. 2 illustrates a body of a conventional can after necking but prior to attaching a lid;

FIG. 3 illustrates a flexible can liner with dimples formed on an outer surface;

FIG. 4 illustrates a hexagonal spacing arrangement for the dimples of FIG. 3;

FIG. 5 illustrates a rigid outer container part, with regions of adhesive around a circumferential upper portion and at a base portion;

FIG. 6 illustrates a flexible can liner having a built-in evacuation valve with a twist seal;

FIG. 7 is a cross-sectional view of a thermally insulating material;

FIG. 8 illustrates a process for manufacturing the material of FIG. 7;

FIG. 9 is a cross-sectional view of a beverage container manufactured using the material of FIG. 7;

FIG. 10 is a vertical cross-section of a beverage container according to a further embodiment of the present invention;

FIG. 11 is a horizontal cross-sectional view of the beverage container of FIG. 10;

FIG. 12 is a vertical cross-section of a beverage container according to a further embodiment of the present invention;

FIG. 13 is a horizontal cross-sectional view of the beverage container of FIG. 13;

FIG. 14 illustrates a vertical cross-sectional view of a first neck portion design for the container of FIG. 12;

FIG. 15 illustrates a vertical cross-sectional view of a second neck portion design of the beverage container of FIG. 12; and

FIG. 16 illustrates a block for cooling beverage containers.

### DETAILED DESCRIPTION OF CERTAIN EMBODIMENTS

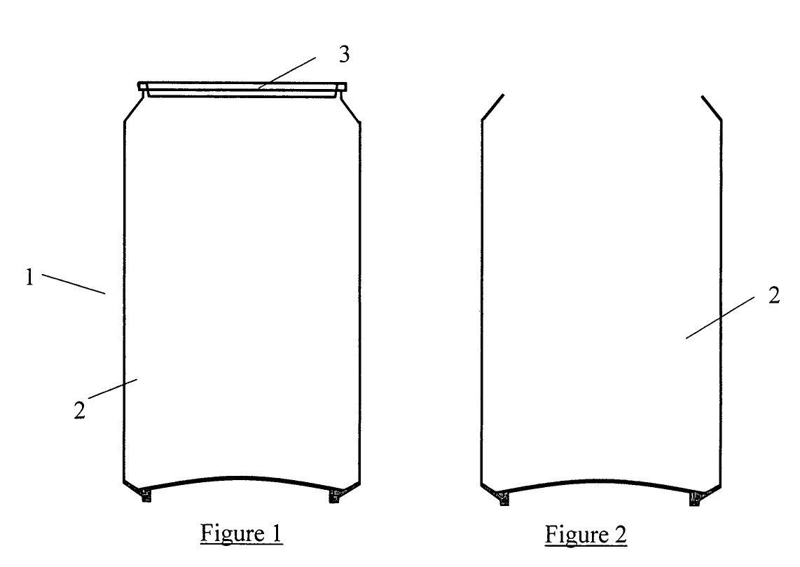

A conventional metallic beverage can 1 is illustrated in FIG. 1 and is typically formed from a cylindrical body portion with integrally formed body 2, and a lid closure 3. The body portion 2 of the can is illustrated separately in FIG. 2, following “necking” but prior to attachment of a lid. Such body portions may be manufactured by a drawings and ironing process.

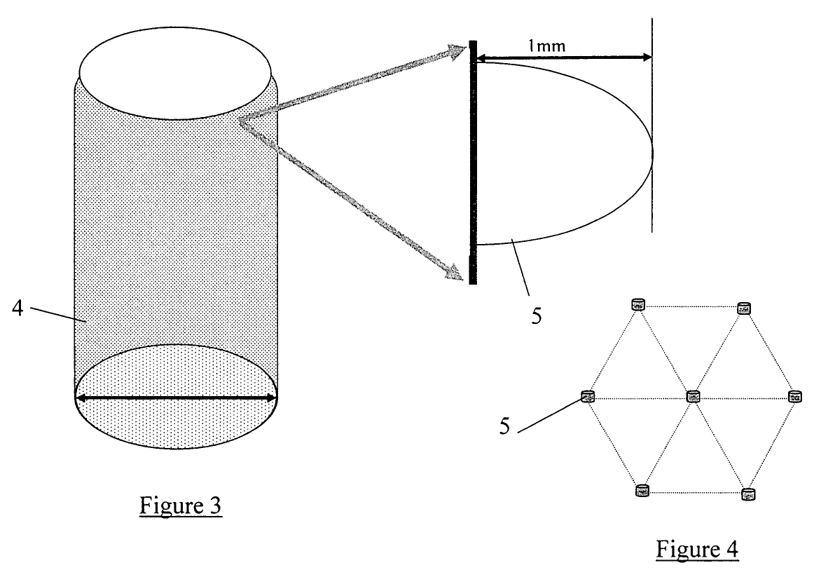

In the beverage can according to the present invention, a conventional body as shown in FIG. 2 can be utilised. In addition, a flexible pouch 4 is inserted into the body. Such a pouch is illustrated in FIG. 3, in an expanded or inflated configuration. The pouch is for example of metal foil or silvered plastics, and, in the expanded configuration, has a generally cylindrical shape which conforms to the shape of the base. The pouch 4 has a base, and a circular opening at its upper end. As illustrated in FIG. 3, dimples 5 are provided over the outer surface of the pouch. FIG. 4 illustrates a possible hexagonal configuration of the dimples 5 (the dimples may be more closely spaced than illustrated in the Figure). The dimples may be formed integrally with the pouch material, or may be in the form of small spacer elements fixed or adhered to the surface of the pouch. A possible material for the spacers is that known as aerogel (see below for further details).

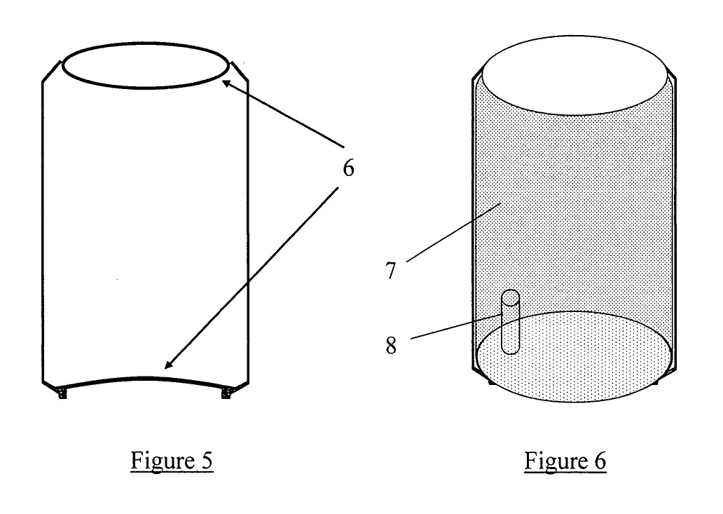

During production, a circular region around the “neck” of the can body 2 is coated with an adhesive 6. A small amount of adhesive 6 is also placed on the inside surface of the base. This is illustrated in FIG. 5. The pouch 4 is inserted, in deflated condition, into the can body 2. The pouch 4 is then inflated using compressed air. (alternatively, the pouch may be constructed in such a way that it is self-expanding.) This forces the pouch 4 into contact with inner walls of the can body. The pressure is such that even the areas between the dimples contact the base. A seal is then formed between the pouch 4 and the can body 2 at the adhesive coated regions. Sealing may be enhanced by applying pressure around the neck region and/or heat. The air pressure is then reduced, and in consequence the pouch relaxes slightly, forming a vacuum in the space between the pouch and the can body. However, the pouch 4 still retains a cylindrical shape due to the force of the partial vacuum created in the space between the pouch and the can body. The dimples 5 ensure that such a space exists, and that the pouch 4 and can body do not contact one another over significant areas.

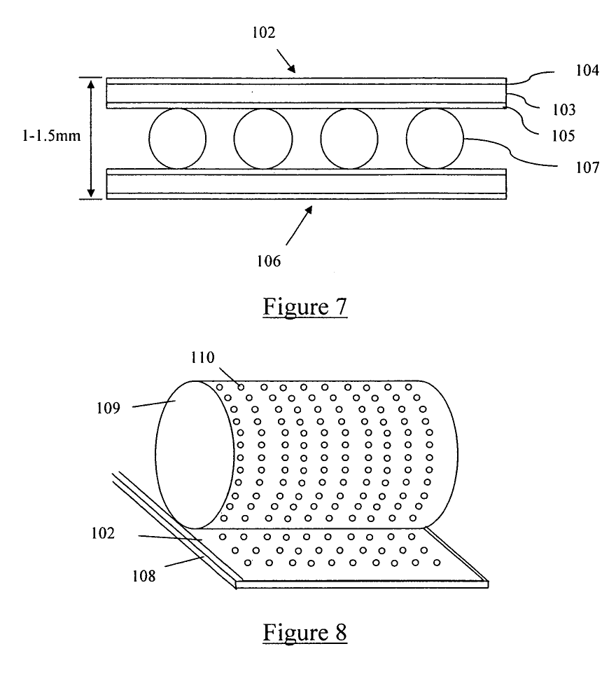

FIG. 6 illustrates a pouch 7 which might be used in an alternative production process. Rather than forming a vacuum in the insulating space by inflating the pouch, a valve 8 is provided in the pouch which allows the pouch to be inserted into the can body, sealed, and air withdrawn through the vale. This pulls the pouch outwardly so that the dimples contact the inner walls of the can body. A partially evacuated space remains.

In yet another alternative production process, a partial vacuum may be formed between the pouch and the base by depositing an oxygen scavenging pellet or powder (getter) in the intervening space. This may be iron filings (contained in a sachet). This may have wider applications in producing a partial vacuum in a beverage container so as to insulate the contents of the container.

Known liquid containers removed from a cold storage device can only retain their lowered temperature if stored in thermal boxes or other devices specifically designed to shield their contents from the external thermal environment, e.g. polystyrene can holders. Using a container as described here, a liquid container may be stored in a cold storage device, removed, and the contents used (in the case of a beverage, be consumed) at a later time whilst retaining its cold temperature. Furthermore, the container may be constructed to the same dimensions as existing containers, thereby requiring no redesign of the external appearance of the container, or to cooperating devices, e.g. vending machines.

In addition to these advantages, the container can be made to look substantially identical to the conventional metallic beverage can. This will reduce consumer resistance to the introduction of a new product. Yet another advantage is that the feel of the container will be similar to the conventional container, and will present the drinker with the pleasant metal on tongue and lip sensation which, as mentioned above, is preferable to the taste and feel of plastic. Yet another advantage is that the combination of metal outer and plastics inner should provide an environmentally friendly can which can be recycled.

There is illustrated in FIG. 7 a thermally insulating material 101 suitable for forming a beverage container (or indeed for performing some other insulating function such as wrapping a container, providing an insulating layer for clothing, etc). The material comprises a first layer 102 formed of PET (Polyethylene Terephthalate) film 103 having a total thickness of around 0.5 mm or less. A first side of the film 103 is coated with a PVdC coating 104 whilst a second side is coated with an aluminium layer 105, e.g. using a vacuum deposition technique. A second layer 106 of substantially identical construction lies opposite to the first layer 102, with the aluminium coated sides of both layers facing inwards. In order to maintain a predefined spacing between the two layers, an array of spacer elements 107 is affixed to one or both of the layers. The elements 107 are generally spherical in shape, and have a diameter on the order of 1 mm. These elements or formed of a material which has an extremely high porosity, e.g. with a material to space ratio of around 90% or better. A suitable material is that known as aerogel, for example as supplied by Cabot Corporation under the trade mark Nanogel™. The pitch to diameter ratio of the element array is carefully selected in order to maintain the integrity of the material under use conditions (see below). The total thickness of the material is on the order of 1 to 1.5 mm.

Whilst the insulating material illustrated in FIG. 7 comprises only a single layer of spacer elements 107, alternative material constructions may use multiple layers where the elements sit on top of each other. The spacer elements may be bound together with a suitable adhesive to prevent them from moving about between the plastics sheets 102, 106. In yet other embodiments, the space between the plastics sheets may be substantially filled with an aerogel powder, e.g. formed by crushing aerogel balls.

The material of FIG. 7 may be used to form an insulating container by wrapping the material around the outside of a rigid container.

The person of skill in the art will appreciate that the material 101 illustrated in FIG. 7 may be formed using any one of a number of manufacturing processes. One such process involves cutting the first and second layers 102, 106 from a single elongate sheet of pre-formed material, and is illustrated in FIG. 8. A first of these layers 102 is then passed along a conveyor 108 beneath a rotating hollow drum 109. The drum is filled with spacer elements 107 coated with adhesive. The drum 109 is permeated with a regular array of holes 110 (FIG. 8 shows only a small number of holes for illustrative purposes) which are only slightly larger than the spacer elements 107. A guard (not shown) surrounds the drum 109 except for a narrow slit running across the base of the drum, parallel to the axis of the drum. This prevents the spacer elements from falling through the holes in the drum except for the those holes passing directly above the slit. As the drum 109 rotates, spacer elements 107 fall through the holes 110 and the slit onto the aluminium coated surface of the layer 102. The tackiness of the adhesive prevents the elements 107 from rolling out of position. The second layer 106 is then brought into contact with the element coated surface of the first layer 102 via a roller (not shown). The now formed material is then passed through a warm air dryer (not shown) so as to dry the adhesive, without damaging the material, and secure the two layers to the spacers.

Once produced, the space between the layers 102, 106 of the insulating material is substantially evacuated. This may be done by cutting the material into suitably shaped portions and passing the cut sections through an evacuated chamber whilst sealing the edges of the material. This process might also involve sealing intermediate portions of the material, e.g. so that the material is separated into regular isolated sections. These sections may have an area of 1 cm². This construction increases the integrity of the material, such that a leak in one section will not significantly affect the insulating properties of the whole cut sheet.

Other methods of manufacturing the material are:

1) A drum similar to that described above is used, with the layer to be coated being passed over the top of the drum. A negative pressure is applied to the inside of the drum with the surface being perforated with a regular array of holes which are slightly smaller in diameter than the spacer elements. Elements are sucked into the holes by the negative pressure from a holding tray, and are coated on their outer exposed surfaces with an adhesive. Where the plastics layer passes over the drum, the protruding elements adhere to the drum and are removed from the holes. The speed of rotation of the drum and the speed of passage of the plastics layer, together with the dimensions of the hole array in the drum, determine the spacing at which the elements are placed onto the surface of the plastics layer.

2) Dots of adhesive are printed onto the surface of the plastics layer to be coated with spacer elements. The layer is then passed through a tray of elements which adhere to the dots of adhesive. The second plastics layer may have its entire surface coated with adhesive before applying it to the element coated first layer.

3) An electric charge pattern may be “printed” onto the layer to be coated in a similar manner to that used in a photocopier or laser printer. The spacer elements are coated with adhesive and charged, before being applied to the surface of the layer. The elements will tend to adhere only to the charged areas. This process could be enhanced by passing the layer over a tray of elements, so that the spacers are attracted upwardly onto the charged areas.

4) Coating one side of the plastics sheets with an adhesive, and sprinkling the spacer elements onto the sheet. The second sheet is then applied over the spacer elements.

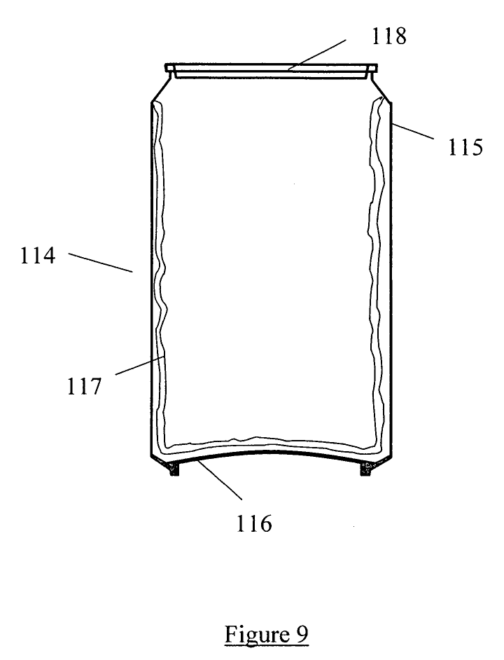

A beverage container 114 is illustrated in FIG. 9 and is formed from three major components. A first of these is a substantially cylindrical metallic outer container 115 (e.g. formed of aluminium, steel, etc), having one end closed by an integrally formed base and the other end open. This container 114 is substantially identical to the body portion of a conventional beverage can. Such can bodies are well known, as are their manufacturing techniques (e.g. drawing and ironing). The only difference of note here is the shape of the base 116 of the outer container 115. The base of a conventional can body is a concave dome, shaped to withstand the internal pressure produced by a carbonated drink. Due to the use of a flexible plastics inserted (to be described), the base of the outer container can be substantially flat, allowing the internal space of the beverage container to be maximised.

The second major component of the beverage container is the inner container 117. This forms a plastics insert which is inserted into the outer container 115 during the manufacturing process. The overall shape of the inner container 117 is substantially identical to that of the outer container, having one end open and the other end closed by a base. The inner container 117 is fabricated using the material described with reference to FIG. 7, and has a shape conforming substantially to that of the outer container 115. The outer surface of the inner container is in contact with the inner surface of the outer container. The inner container is fixed to the outer container at or close to the open end of the inner container, around its entire circumference.

A metallic lid 118 of generally circular shape with a downturned outer rim, which again is of substantially conventional construction having a frangible ring-pull type opening mechanism formed therein, is placed over the open end of the outer container 115 and is fixed thereto to close the container. The lid 118 is typically fixed using an adhesive whilst applying a compression force around the outer rim of the lid, a process known in the industry as “necking”. The step of fixing the lid is generally carried out after filling the container with the required beverage. The fixing step must be carried out under pressure if the beverage is pressurised. Preferably, the inner container 117 extends above the point at which the lid 118 is sealed to the outer container 115.

It will be appreciated that the insertion of the outer container 105 into the outer container 102 reduces the internal space available for containing a beverage. However, the effect of this can be mitigated by the flat base of the container, in contrast to the concave dome shaped base of a conventional can.

The insulation of the contents of the beverage container will be most effective when the container is only filled with liquid up to a level no higher than the top of the inner container 117. The air in the gap above will, when cooled, provide an insulating layer between the contents and the lid, thereby reducing the rate of heat transfer by conduction in a region which might otherwise heat up more quickly.

In a modification to the embodiment described, the insulating material may comprise a substantially continuous base sheet or blanket of highly porous material, e.g. an aerogel. The sheet may be coated on one or both sides with a metallic layer, e.g. aluminium, and a plastics layer. A particularly advantageous manufacturing method would be to coat the base sheet with plastics or metal in a vacuum, during which process the spaces in the base sheet are evacuated. The subsequent coating seals the vacuum. In a modified process, the base sheet is first coated with a plastics layer. This sheet is then penetrated with laser holes, and the sheet then coated with a metal under vacuum. The holes assist in evacuating the spaces in the base sheet.

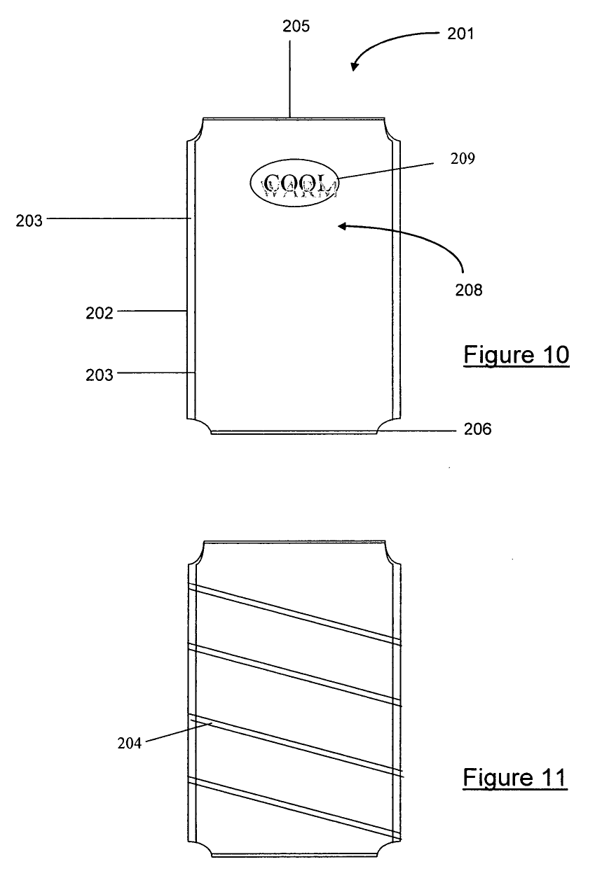

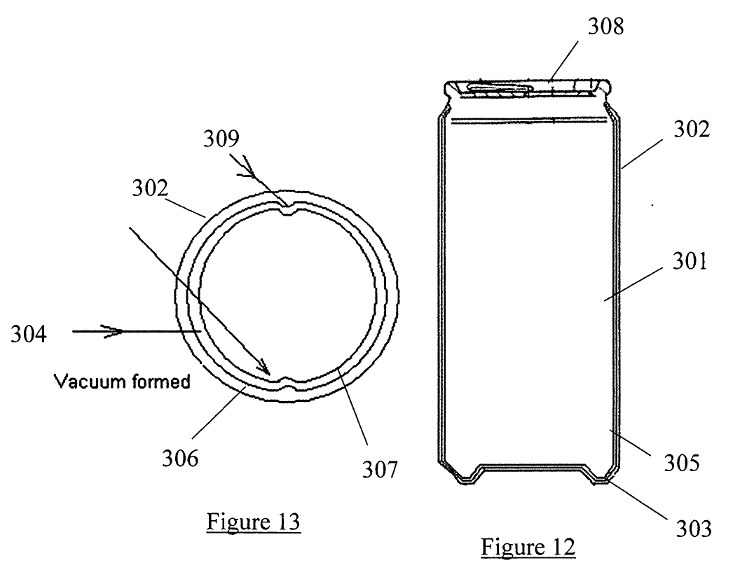

FIGS. 10 and 11 illustrate yet another embodiment of an insulated beverage container 201 which comprises a cylindrical outer wall 202 made from a metal such as aluminium or stainless steel. The container 201 further comprises a second cylindrical wall 203 typically made from the same material as the outer wall 202 and located coaxially within the inner wall such that a small space exists between the two walls 202, 203. The inner wall 203 may have a helically extending rib 204 extending over its outer surface such that the rib contacts the inner surface of the outer wall 202 thus maintaining the spacing between the walls and also increasing the strength of the container. Alternatively, plastic spacer rings may be inserted between the inner and outer walls during manufacture in order to maintain the spacing.

The top and bottom of the container are closed by a top and base ends 205, 206 respectively made of the same material as the side walls 202, 203. The base end 205 may be formed integrally with one of or both of the cylindrical sides walls 202, 203, e.g. by way of a drawing and ironing process. The top end 206 is typically attached to the sides following filling of the container with a beverage. Both the top and the side wall are of single wall construction.

A partial vacuum is formed between the outer wall 202 and the inner wall 203 during the construction and container assembly process. The vacuum will thermally insulate contents 208 of the container from the outside environment. The outer wall 202 and inner wall 203 meet at the top 205 of the container, forming at the intersection a seal around the entirety of the upper edge of both walls to maintain the vacuum. The insulation of the container by the vacuum extends around the entirety of the sides of the container.

The top end 205 of the container 201 is provided with a conventional ring-pull type opening mechanism which makes use of a frangible seal formed between a component of the ring-pull and the surrounding container wall, e.g. formed by pressing a forming tool in the shape of the coupling against the wall. Indeed, the entire top end 205 may be of conventional construction.

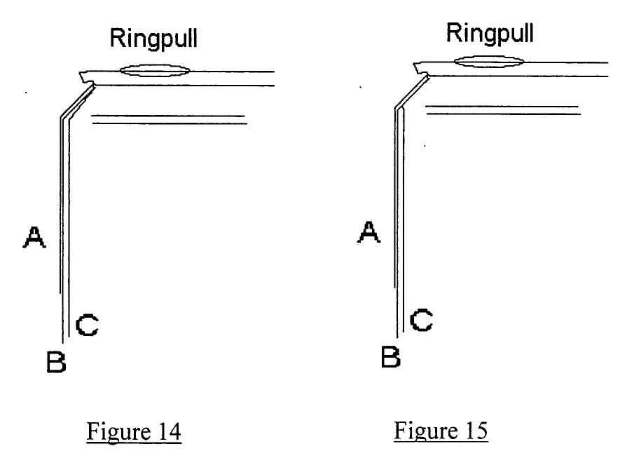

Yet another beverage container 301 design is illustrated in FIGS. 12 and 13 and is formed from three major components. A first of these is a substantially cylindrical metallic outer container 302 (e.g. formed of aluminium, steel, etc), having one end closed by an integrally formed base and the other end open, which may be substantially identical to the body portion of a convention beverage can. Such can bodies are well known, as are their manufacturing techniques (e.g. drawing and ironing). The only difference of note here is the shape of the base 303 of the outer container 302. The base of a conventional can body is a concave dome, shaped to withstand the internal pressure produced by a carbonated drink. Due to the use of a plastics inserted (to be described), the base of the outer container can be substantially flat, allowing the internal space of the beverage container to be maximised.

The second major component of the beverage container is the inner container 305. This forms a plastics insert (e.g. of polypropylene, PTFE, etc) which is inserted into the outer container 302 during the manufacturing process. The overall shape of the inner container 305 is substantially identical to that of the outer container, having one end open and the other end closed by a base. However, the inner container is double walled as shown in FIGS. 12 and 13, with the walls 306, 307 being spaced apart by 1-2 mm except around the upper opening where the walls are sealed together. The space 304 may be maintained by suitable arranged spacers. During the manufacture of the inner container, a vacuum is pulled in the space between the two walls 306, 307. The manufacturing process is typically a moulding process such as a blow moulding process. One or more of the sides of the inner container may be metalised, e.g. with aluminium, to increase the thermal reflectivity of the walls and to increase the impermeability to gasses and provide a barrier to outgassing (see below).

The inner container 305 is inserted into the outer container, with the dimensions of both being such that a compression or interference fit is formed between the two, preventing relative movement of the two components providing limited space for the ingress of fluid from the interior space (after filling of the container, se below). The gap between the containers 302, 305 apparent in Figures is for illustrative purposes only. The container in this state is typically provided to the “bottler” who fills the container (up to or close to the top of the inner container 305) with the chosen beverage. If necessary, this step is carrier out under pressure. A metallic lid 308 of generally circular shape with a downturned outer rim, which again is of substantially conventional construction having a frangible ring-pull type opening mechanism formed therein, is placed over the open end of the outer container 302 and is fixed thereto to close the container. The lid 308 is typically fixed using an adhesive whilst applying a compression force around the outer rim of the lid. The step of fixing the lid must be carried out under pressure if the beverage is pressurised.

Preferably, the inner container 305 extends above the point at which the lid 308 is sealed to the outer container 302. This is advantageous as it will maximise the thermal insulation provided to the container contents. This is illustrated in FIG. 14, where the outer container is identified as “A”, the outer wall of the inner container by “B”, and the inner wall of the inner container by “C”. However, the inner container 305 may stop beneath the “necking” joint if that is desirable from a manufacture point of view. This embodiment is illustrated in FIG. 15.

The inner container 305 is formed from a rigid or semi-rigid plastics material. As such, it adds a significant degree of strength to the beverage container. A significant advantage of this feature is that the walls of the outer container 302 can be made thinner than those of conventional beverage cans, given that they no longer have to withstand the same internal pressure. This results in a cost saving for manufacturers, given that the cost of the inner plastics container may be significantly less than that of the outer container. In addition, because plastic is significantly lighter than metal, the total weight of the new container design may be less than that of the conventional metal can. Of course, in an alternative construction, the double walled insert 305 is formed of a metal, e.g. aluminium. In order to ensure that the insert has sufficient strength, corrugations may be formed in the walls.

It will be appreciated that the insertion of the outer container 305 into the outer container 302 reduces the internal space available for containing a beverage. However, the effect of this can be mitigated by the flat bases of the containers, in contrast to the concave dome shaped bases of conventional cans.

As is illustrated in FIG. 13, a groove 309 may be formed axially along the lengths of each of the walls of the inner container 305. This groove provides a channel along which air may flow as the inner container 305 is pushed into the outer container, thus easing the insertion process and avoiding damage due to a pressure build-up.

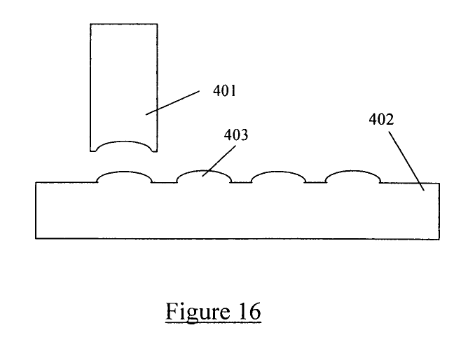

The containers described above will have a potential drawback in that it will take longer to cool the contents to a desirable temperature. This problem may be overcome by storing the containers 401 within a refrigerator, mounted on a heat sink block 402. This block may be for example of aluminium. Typically, a container base will be concave in shape, with the base being single walled as shown in FIG. 16. By forming convex projections 403 of complimentary shape on the upper surface of the heat sink block, a means is provided for forming a good thermal “connection” to the container bases. As the bases are single walled, the contents will tend to be cooled relatively rapidly.

In those containers utilising an evacuated space to provide thermal insulation, means may be provided for allowing liquid to enter the evacuated space between the double walls, when the can is opened and the internal pressure released. For example, a valve could be provided in the innermost wall arranged to conduct fluid when the internal pressure falls below a given pressure. Alternatively, means could be provided which ruptures when the pressure falls below a given pressure, allowing fluid to enter the space. An advantage of this arrangement is that the liquid entering the space will quickly cool the outer metallic container, allowing the drinker to sense the cool liquid contents. This may be desirable from the drinker's point of view.

In an improvement to the insulated containers described above, a visual indicator may be provided on the side of the container to provide a measurement indicative of the temperature of the contents of the container, e.g. thermally activated (thermochromic) material being applied to at least one region of the wall of the container. This is illustrated in FIG. 10 by reference numeral 209. The temperature indicator can be constructed from materials such as a liquid crystal, in which case a layer of the liquid crystal material is applied to the external wall of the container. The visual indication might be red when the temperature of the contents is above 20 degrees Celsius, and blue when the temperature of the contents is below 12 degrees Celsius. These temperature values will vary according to the desired temperature range of the contents of the container. A temperature indicator provides a quantitative measure of the temperature, rather than having to rely on a qualitative tactile reading.

The temperature indicator may be designed to be incorporated into a word, for example “WARM”, red in colour when the contents are above a first threshold temperature, and “COOL”, blue in colour when the contents are below a second, lower, threshold temperature. The indicator may alternatively be a temperature scale, with a mark indicating the temperature of the contents on the scale, in a similar manner to a thermometer. The indicator can be incorporated into a manufacturer's logo or other similar design on the outer wall of the container.

It is appreciated that the external wall of the container is not in direct thermal contact with the contents and correspondingly the temperature indicator is designed with a time lag, calculated according to the known thermal characteristics of the contents of the container. Upon removal from a cold storage device, the external wall of the container will approach ambient temperature at a faster rate than the contents due to the vacuum insulation of the contents. The temperature indicator is designed to produce a measurement of the temperature of the contents of the container based upon the temperature of the external wall of the container, the thermal transfer characteristics of the container, and the specific heat capacity of the contents of the container. For example, the indicator may indicate the ambient temperature with a delay of around 8 hours, representing the time taken to chill the contents of the can (or to warm the contents up after chilling). The indicator this solves the problem inherent with known indicators such as that described in GB2334092.

It will be appreciated that a thermal indicator of the type described above has more general applicability than merely to beverage containers. For example, an indicator exhibiting a time-lag may be used to indicate when a frozen product has been removed from a freezer for some predefined time. In the case of a frozen meal having a defrost time of 5 hours, an indicator having a time-lag of 5 hours could be fixed to the outer packaging of the meal. 5 hours after removal of the meal from the freezer, the indicator would change state to indicate the message “READY”. Similarly, a wound dressing could have an indicator configured to indicate when the dressing has been attached to the skin for some predefined time and can be removed (based upon body temperature).

Known liquid containers removed from a cold storage device can only retain their lowered temperature if stored in thermal boxes or other devices specifically designed to shield their contents from the external thermal environment, e.g. polystyrene can holders. Using a container according to the present invention, a liquid container may be stored in a cold storage device, removed, and the contents used (in the case of a beverage, be consumed) at a later time whilst retaining its cold temperature. Furthermore, the container may be constructed to the same dimensions as existing containers, thereby requiring no redesign of the external appearance of the container, or to cooperating devices, e.g. vending machines.

In addition to these advantages, the container can be made to look substantially identical to the conventional metallic beverage can. This will reduce consumer resistance to the introduction of a new product. Yet another advantage is that the feel of the container will be similar to the conventional container, and will present the drinker with the pleasant metal on tongue and lip sensation which, as mentioned above, is preferable to the taste and feel of plastic.

A container according to the present invention provides a convenient way of maintaining liquids at a low temperature for a long period of time without the need for separate thermal insulation. In addition, the combination of metal outer and plastics inner should provide an environmentally friendly can which can be recycled.

It will be appreciated by the person skilled in the art that various modifications may be made to the above embodiments without departing from the scope of the present invention. In one modification, a gap or hole is provided in an outer container such that an inner container can be viewed through the gap or hole. This may be desirable for example to allow the user to see the structure of the can and/or to provide a visually interesting advertisement. In yet another modification, the metallic outer container may be replaced by a glass or rigid plastics or cardboard container. The container may be in the shape of a bottle, rather than a can.

1. A beverage container comprising:
a body section comprising an outer metallic wall and an inner wall, the inner wall defining an inner space for containing a liquid or material, a space adjacent to the inner wall being substantially evacuated to provide thermal insulation to the inner space; and
an open-only lid sealingly attached to the body section to close an opening therein.

2. A container according to claim 1, wherein the lid substantially comprises a single layer of metal and has formed therein a ring-pull opening mechanism.

3. A container according to claim 2, wherein the evacuated space lies between said inner and outer wall.

4. A container according to claim 3 and comprising a third wall located between said inner and outer walls, the evacuated space lying between the inner and the third wall.

5. A container according to claim 4, said inner wall and said third wall being of a plastics material.

6. A container according to claim 5, said plastics material being a rigid or semi-rigid plastics material.

7. A container according to claim 5, said plastics material being a flexible plastics material.

8. A container according to claim 4 and comprising one or mare spacer elements located between the inner and third walls so as to maintain a separation between the walls.

9. A container according to claim 8 and comprising a multiplicity of spacer elements.

10. A container according to claim 9, said spacer elements being formed of a porous material.

11. A container according to claim 10, wherein said porous material is an aerogel.

12. A temperature indicator for indicating the internal temperature of an insulated container, the temperature indicator being disposed on the external surface of the container and providing a visual indication of the temperature of its contents.

13. A temperature indicator according to claim 12, wherein the indicator comprises means responsive to the external temperature with a time lag substantially corresponding to the time lag with which the contents of the container respond to the external temperature.

14. A temperature indicator according to claim 12, wherein the time lag is defined according to the thermal transfer characteristics of the container and the specific heat capacity of the contents of the container.

15. A temperature indicator according to claim 12, wherein the visual indication is a colour change.

16. A temperature indicator according to claim 12, wherein the visual indication is an increase or decrease of a mark on a calibrated scale.

17. A thermally insulating material comprising:
first and second opposed flexible sheets, the sheets being impermeable;
spacer means which is in contact with both the first and second sheets,
wherein the space between the first and second sheets is substantially evacuated.

18. A method of manufacturing a thermally insulating material, the method comprising:
attaching spacer means to one side of a first flexible, impermeable sheet;
applying a second flexible, impermeable sheet on top of the spacer means so that the first and second sheets are spaced apart from one another; and
substantially evacuating the space between the first and second sheets and forming an airtight seal between the sheets.

19. A container comprising:
first and second opposed flexible sheets, the sheets being impermeable;
spacer means which is in contact with both the first and second sheets,
wherein the space between the first and second sheets is substantially evacuated, the combined sheets being shaped to provide an inner, insulated space for containing a substance.

20. A beverage container comprising, a substantially rigid outer container and an inner container disposed within the outer container, the inner container comprising:
first and second opposed flexible sheets, the sheets being impermeable;
spacer means which is in contact with both the first and second sheets,
wherein the space between the first and second sheets is substantially evacuated,
the combined sheets being shaped to provide an inner, insulated space for containing a beverage.

21. A beverage container comprising a substantially rigid inner container shaped to provide an inner space for containing a beverage, and an outer container disposed around the inner container, the outer container comprising:
first and second opposed flexible sheets, the sheets being impermeable; and
spacer means which is in contact with both the first and second sheets,
wherein the space between the first and second sheets is substantially evacuated.

22. A container according to claim 19, wherein said spacer means comprises a highly porous material.

23. A container according to claim 22, wherein said highly porous material is an aerogel.

24. A container according to claim 19, wherein said spacer means comprises a substantially continuous sheet.

25. A container according to claim 19, wherein said spacer means comprises a multiplicity of spacer elements.

26. A beverage container comprising a body section having an outer wall and an inner wall, the inner wall defining an inner space for containing a liquid or material, a highly porous material substantially filling the space between the inner and outer walls, wherein the space containing the highly porous material is substantially evacuated.

27. A beverage container according to claim 26, wherein said highly porous material is aerogel.

28. A method of manufacturing a beverage container, the method comprising:
inserting a flexible inner container into a rigid outer container, the inner container comprising first and second opposed flexible sheets, the sheets being impermeable, and spacer means which is in contact with both the first and second sheets,
wherein the space between the first and second sheets is substantially evacuated.

29. A method of providing a visual indication of the historical temperature to which a product or material has been exposed, the method comprising placing a thermal indicator in thermally conductive contact with the product or material, the thermal indicator providing a visual indication of temperature and comprising a thermally sensitive material which exhibits a time-lag response.

30. A method according to claim 29, wherein said time-lag response causes the visual indication of temperature to lag the temperature of the product or material by at least one hour.

31. A container according to claim 20, wherein said spacer means comprises a highly porous material.

32. A container according to claim 21, wherein said spacer means comprises a highly porous material.

33. A container according to claim 20, wherein said spacer means comprises a substantially continuous sheet.

34. A container according to claim 21, wherein said spacer means comprises a substantially continuous sheet.

35. A container according to claim 20, wherein said spacer means comprises a multiplicity of spacer elements.

36. A container according to claim 21, wherein said spacer means comprises a multiplicity of spacer elements.

37. A container according to claim 34, wherein said highly porous material is an aerogel.

38. A container according to claim 32, wherein said highly porous material is an aerogel.
